(19) United States
(12) Patent Application Publication
(10) Pub. No.: US 2011/0043503 A1
(43) Pub. Date: Feb. 24, 2011

(54) SPECTRALLY COMPENSATING A LIGHT SENSOR

(76) Inventor: Benjamin James Hadwen, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/863,346

(22) PCT Filed: Jan. 21, 2009
(86) PCT No.: PCT/JP2009/051298

§ 371 Date: Jul. 16, 2010

(30) Foreign Application Priority Data
Jan. 22, 2008 (GB) 0801120.7

(51) Int. Cl. G09G 5/00

(52) U.S. Cl. 345/207

(57) ABSTRACT

A light sensor comprises a first photodetector (52) sensitive in a first wavelength range; a second photodetector (60) sensitive in a second wavelength range different from the first wavelength range; and a processor for determining, using the output of the second photodetector, a correction to the output of the first photodetector for compensating the output of the first photodetector for a difference between the spectral response characteristic of the first photodetector and a reference spectral response characteristic. The processor is adapted to apply the correction to the output of the first photodetector. For example, the first photodetector (52) may be sensitive over the entire visible wavelength range and the second photodetector (60) may be sensitive in a blue wavelength range—this allows the output of the first photodetector to be corrected for an increased sensitivity in the blue wavelength range compared to the reference spectral response characteristic. The light sensor may be used in an Ambient Light Sensing (ALS) system, for example in the ALS of a display.

### TECHNICAL FIELD

The present invention relates to spectrally compensating a light sensor, for example a light sensor of an Ambient Light Sensor (ALS) system. The invention may be applied to a light sensor that is integrated into an active matrix liquid crystal display (AMLCD).

This invention finds particular application in the integration of an ambient light sensor (ALS) on an AMLCD display substrate (shown FIG. 1).

### BACKGROUND ART

FIG. 2 shows a simplified cross-section of a typical AMLCD. The backlight 128 is a light source used to illuminate the display. As is conventional, the display comprises a layer 104 of liquid crystal material disposed between transparent (eg glass) substrates 103, 105. Polarisers are provided, one on each side of the liquid crystal layer. The transmission of light through the display, from the backlight 128 to the viewer 102, is controlled by the use of electronic circuits made from thin film transistors (TFTs). The TFTs are fabricated on a glass substrate (known as the TFT glass 103) and are operated so as to vary the electric field through the Liquid Crystal (LC) 104 layer. This in turn varies the optical properties of the LC cell and thus enables the selective transmission of light through the display, from the backlight 128 through to the viewer 102.

Colour images can be displayed by the AMLCD by employing the use of colour filters. Such colour filters are formed by the deposition of suitable colour filter material 106 onto the top glass 105. Alternative implementations are also possible whereby the colour filter materials are deposited onto the TFT glass 103.

The colour filter materials are chosen so as to be able to transmit light only within a particular range of wavelengths (the filter's pass band). In a typical colour display three colour filters may be used, for example to transmit Red, Green and Blue (RGB) light respectively. Thus a pixel (or sub-pixel) in the display will generally have one of the red, green or blue filters placed over it and thus transmit either red, green or blue light accordingly. Typical filter characteristics suitable for use in an AMLCD are shown in FIG. 3. The filter transmission as a function of wavelength is shown for red 32, green 34 and blue 36 filters respectively. Various alternative schemes for colour rendition are also possible.

In many products which utilise displays (e.g. mobile phones, Personal Digital Assistants (PDAs)) it is found to be useful to control the light output of the backlight according to ambient illumination conditions. For example under low ambient lighting conditions it is desirable to reduce the brightness of the display backlight and hence also the brightness of the display. As well as maintaining the optimum quality of the display output image, this allows the power consumed by the backlight to be minimised.

In order to vary the intensity of the backlight in accordance with the ambient lighting conditions, it is necessary to have some means for sensing the level of ambient light. An ambient light sensor (ALS) used for this purpose could be separate from the TFT glass substrate. However there are several advantages of integrating the ALS onto the TFT glass substrate (“monolithic integration”), for example in reducing the size, weight and manufacturing cost of the product containing the display.

A typical practical ambient light sensor system for use with a display will, as shown in FIG. 1, contain the following elements:

(a) A photodetection element (or elements) capable of converting incoming light to electrical current. An example of such a photodetection element is a photodiode 135.

(b) Ambient Light Sensor drive circuit 134 to control the photodetection element(s) and sense the photo-generated current.

(c) Ambient Light Sensor Output circuitry 136 to supply an output signal (analogue or digital) representing the measured ambient light level.

(d) A means of adjusting operation of the display, in FIG. 1 exemplified as a display pixel matrix 120, based on the measured ambient light level, for example by controlling the intensity of the backlight 128.

Possible implementations of such a system have been well described elsewhere, for example in UK patent application Nos. 0619581.2 and 0707661.5 and in “The System-LCD with Monolithic Ambient-Light Sensor System”, K. Maeda et al., Proceedings of the SID, May 2005.

In general such a system is designed to operate in a wide variety of (white) lighting environments, for example in sunlight, with fluorescent room lighting, with sodium lighting (e.g. from streetlights), or with incandescent room lighting etc. Although to the human eye many of these light sources appear to be essentially white (or close to white), their spectral characteristics can in fact be very different. As an example FIG. 4 shows the relative spectral response characteristics of a number of different common or laboratory light sources: a 5500K blackbody 10 (which approximates to the spectrum of sunlight), Standard A halogen 12, CSS (white) LED 14, metal halide 3-additive 16, 3-band fluorescent 18, and high pressure sodium 20. It is of note that both the shapes, and the wavelength of maximum output can vary considerably between the different light sources.

In the system of FIG. 1 the photodetection element operates by absorbing the light incident upon it. The usual mechanism of photon absorption in such a sensor is the photoelectric effect, a mechanism that is well described in many standard textbooks. The absorption of photons by this mechanism creates mobile carriers (electrons and or holes) in the semiconductor material. One or both polarities of carriers are then able to contribute to a net current flow through the device. By sensing the amount of current generated in response to a given level of illumination, the incident ambient light level can then be measured.

In the case of an AMLCD with a monolithically integrated ambient light sensor, the basic photodetection device used must be compatible with the TFT process used in the manufacture of the display substrate. A well-known photodetection device compatible with the standard TFT process is the lateral, thin-film, polysilicon P-I-N diode, a possible implementation of which is described in UK patent application No. 0702346.8. Other photodetection devices compatible with the standard TFT process are also possible, for example photo-transistors, photo-resistors, etc.

The ability of a given semiconductor material (for example silicon) to absorb the light incident upon it is in general dependent upon the wavelength of the incident light. This dependency is typically quantified by the optical absorption coefficient of the material, expressed as a function of the wavelength. For example the optical absorption coefficient of bulk crystalline silicon is shown in FIG. 5. It may be noted that the absorption coefficient is approximately exponential with wavelength, being significantly higher at short wavelengths (towards the blue) than at longer wavelengths (towards the red).

For a typical photodetection device there are also a number of other factors which determine the extent to which incident light of a given wavelength is absorbed. The most important of these are the thickness of the active (i.e. photosensitive) region of material and the reflection and absorption properties of the non-photosensitive material at the front and back interfaces. A convenient measure of the ability of a detector to detect incident light is the Quantum Efficiency (QE), defined as the percentage of light of a given wavelength that is detected by the device. It is also useful to define the relative QE as the QE appropriately normalised so as to be equal to 1 at the wavelength where it is a maximum. FIG. 6 shows the typical QE of a bulk silicon photosensor device, for example a Charge Coupled Device (CCD). Typically such a device is sensitive between wavelengths of 400 nm and 1060 nm. At short wavelengths, where the semiconductor material is a good absorber of the incident light, the sensitivity is generally limited by surface reflections and by absorption of light in non photosensitive parts of the device (e.g. depending on exact the construction of the device these could be passivation layers, gate insulator layers, etc). At longer wavelengths the semiconductor material is a much poorer absorber of the incident light. As a result photons of long wavelengths often pass straight through the material undetected. As a result the peak sensitivity is typically in the range 600-700 nm, although this will depend on the exact construction of the device and the details of any antireflection (AR) coating that may be used.

In the case of a thin film silicon photodetector element, a key characteristic is the depth of the photosensitive region. By nature of the technology being thin film, this is generally much smaller than would be the case for a photodetection element fabricated in a bulk semiconductor process. For example the thickness of the silicon layer in a typical AMLCD process will be of order a few tens of nanometres. This has profound consequences for the spectral response characteristic. FIG. 7 shows the typical spectral response characteristic of a thin film photodetector. It should be noted that the spectral response is very strongly peaked towards the blue (short wavelengths). This is because the active depth of silicon is sufficiently small such that most of the incident light of longer wavelengths passes straight through the semiconductor without being absorbed. Consequently the probability of a photon of given wavelength being absorbed (and therefore detected) is approximately proportional to the optical absorption coefficient at that wavelength.

In general it is desirable for an ALS system that the response of the photodetection element be well spectrally matched to the eye. A well spectrally matched photodetection element can be defined as one which senses the same brightness of ambient light as is perceived by the human eye, irrespective of the spectral characteristics of the illumination source. Therefore the measurement unit for quantifying the measured brightness should in general be photopic (i.e. weighted to the response of the human eye). An example of such a photopic unit is the lux. A detailed explanation of the proper definitions and uses of photopic measurement units can be found, for example, in “Methods of Characterizing Illuminance Meters and Luminance Meters”, CIE technical Report 69-1987, ISBN 3 900 734 04 6.

By definition, a photodetection element that is perfectly spectrally matched to the human eye is one that has the same relative quantum efficiency as the human eye. FIG. 8 shows the relative QE of the human eye, a characteristic that is better known as the “luminous efficiency function”. This quantity must be obtained by empirical measurement and is defined as an international standard which can be found in “Photopic CIE Luminous Efficiency Functions based on Brightness Matching for Monochromatic Point Source 2° and 10° Fields”, CIE Technical Report 75-1988 ISBN 3 900 734 11 9. Denoting the luminous efficiency function as V(λ), the perceived brightness of an illumination source (in lux) as perceived by the eye P_{eye} can be written as:

P_{eye}=E∫V(λ)I(λ)dλ (1)

where E is a wavelength independent scaling factor and I(λ) is the relative spectral response function of the illumination source being perceived. The integral must be performed over all the wavelengths for which the eye is sensitive. Similarly for a photodetection element whose relative quantum efficiency function is Q(λ), the measured brightness is given by

P_{det}=D∫Q(λ)I(λ)dλ (2)

In this case the integral must be performed over all the wavelengths for which the detector is sensitive. Here D is a wavelength independent scaling constant that essentially corresponds to the gain of the detector.

One possible measure of the spectral mismatch of a photodetector is the parameter f₁ which is expressed as a percentage and may be defined as

$${f}_{1} = 100 ( 1 - \frac{{P}_{det}}{{P}_{eye}} ) \qquad ( 3 )$$

In the case of a perfectly spectrally matched light source, V(λ)=Q(λ) and it is readily apparent that by setting E=D f₁ will always be zero, independent of the illumination source spectral characteristic I(λ). If the eye and the detector are not perfectly matched spectrally then, by definition, V(λ)≠Q(λ) for at least some wavelengths λ. Since the choice of scaling constant D is arbitrary, f₁ may be minimised for any one particular light source (or combination of light sources) but cannot be made zero for all I(λ).

In general, the calculated values of f₁ are greater for a thin film silicon detector than for a detector based in a typical bulk process. For sensor applications where spectral matching to the human eye is important it is nearly always necessary to implement some method of spectral correction. For example, for a photodetection element whose relative QE is as shown in FIG. 7, and with no spectral correction implemented, the perceived difference in brightness by the detector of two light sources having identical lux values (i.e. two light sources that would be perceived to be the same brightness as the eye), may be as much as 5 times, depending on the spectral characteristics of the light sources.

A conventional method for modifying the spectral response characteristics of a photosensor is to place one or more colour filters over the photosensitive region. This very well known technique is the basis of most modern colour image sensors (e.g. see EP00449477A1, U.S. Pat. No. 4,249,203, U.S. Pat. No. 5,253,047). If the colour filter has a spectral transmission characteristic f(λ) then the detector response is modified to become

P_{det}=D∫f(λ)Q(λ)I(λ)dλ (4)

Applied to an ambient light sensor (which is in effect a 1-pixel image sensor) this technique may be implemented for example by placing one or more colour filters over the sensor active area. For an ALS integrated onto an AMLCD one possibility would be to use the same RGB colour filters used in the active area in the display and whose transmissions are as FIG. 3. These filters can be placed over the photodetection element without any requirement for additional processing steps in the standard AMLCD fabrication process. One possibility would be to place the green colour filter over the whole of the photosensitive region of the photodetection element. This will result in a spectral response characteristic that is more closely matched to that of the eye, since the green colour filter transmission characteristic (as shown FIG. 3) is reasonably similar to the photopic luminous efficiency function as shown FIG. 8. A further possibility would be to place a green colour filter over part of the photosensitive region, a blue colour filter over part of the photosensitive region and a red colour filter over part of the photosensitive region.

There are, however, two significant disadvantages associated with this method. Firstly the spectral matching to the eye (for example as quantified by the parameter f₁), whilst being improved upon compared to the uncorrected sensor, may still be quite poor in comparison with a bulk photosensor device. This is generally a consequence of the exponential nature of the sensor QE, combined with the relatively broad pass bands of the colour filters and the small though significant amount of leakage of the green and red filters at short wavelengths.

A second disadvantage is that the use of colour filters significantly reduces the proportion of the incident light that can be detected by the sensor (since much of the light is absorbed or reflected by the colour filter). This is a significant disadvantage since in general it is difficult to design a thin film photodetector capable of measuring the low levels of ambient light required by an ALS.

U.S. Pat. No. 6,727,521 describes a means for producing a colour sensor using a vertical stack of photodetectors. The different photodetectors have different spectral response characteristics according to their positions in the stack. An advantage of this technique is that an increased spatial resolution can be achieved, for example in image sensor applications. A disadvantage is the extra complexity introduced. This method would not therefore be at all well suited to a thin film process where just a single thin film layer of semiconductor material is deposited.

US20060177127 describes a means of spectrally correcting an image according to the statistical distribution of the different colour outputs of all of the pixels, to improve the colour fidelity pixel by pixel. A disadvantage of this method is that a large number of output pixels of data are required to obtain statistical information.

EP1107222 and EP1703562 relate to correcting for sensitivity in the infra-red (IR) part of the spectrum. EP1107222 for example is directed to a photodetector that has two silicon photodiodes, of which one is daylight filtered. The unfiltered photodiode is sensitive to wavelengths from approximately 400 nm to 1100 nm, whereas the daylight-filtered photodiode is sensitive only from approximately 750 nm to 1100—that is, in the IR part of the spectrum. The output of the daylight-filtered photodiode may be used to correct the output of the unfiltered photodiode for sensitivity in the IR part of the spectrum. EP1107222 does not however address differences between the spectral characteristic of a silicon photodiode and a desired spectral characteristic.

GB2419665 refers to a light detector having two or more sensors that are sensitive in different regions of the spectrum, for example sensors sensitive to IR light, to visible light, and to UV light. The outputs of the sensors are compared with stored data sets, in order to identify the type of light environment.

U.S. Pat. No. 623,945 relates to a fire detection system which has a plurality of sensors, for example a wide band IR sensor, a visible sensor and a near band IR sensor. The wide band IR sensor acts as the primary sensor for detecting a fire, and the other sensors are used to prevent false triggering of the alarm.

### DISCLOSURE OF INVENTION

A first aspect of the invention provides a light sensor comprising: a first photodetector sensitive in a first wavelength range; a second photodetector sensitive in a second wavelength range different from the first wavelength range; and a processor for determining, using the output of the second photodetector, a correction to the output of the first photodetector for compensating an output of the first photodetector for a difference between a spectral response characteristic of the first photodetector and a reference spectral response characteristic; wherein the first wavelength range substantially corresponds to a wavelength range of interest; and wherein the second wavelength range is a part of the wavelength range of interest.

In general a photodetector has an active area of finite extent. The invention does not necessarily require that a photodetector has spectral characteristics that are constant over its entire active area (or effective area), and the spectral characteristics may vary over the active area. Specifying that a photodetector is sensitive in a wavelength range does not necessarily require that the photodetector is sensitive in that wavelength range over its entire active area, and in some embodiments it may be sufficient if the photodetector is sensitive in that wavelength range over only part of its entire active area.

The wavelength range of interest may be a visible wavelength range. It may correspond substantially to the visible spectrum—that is, cover the wavelength range from approximately 400 nm to approximately 700 nm.

The processor may further be adapted to apply the correction to the output of the first photodetector, thereby to correct the output of the first photodetector for the difference between the spectral response characteristic of the first photodetector and the reference spectral response characteristic.

The second wavelength range may, for example, be a subset of the first wavelength range. In one example, the second wavelength range is a wavelength range in the blue region of the spectrum, and the first wavelength range corresponds to the visible wavelength range. This would be appropriate where the detector is more sensitive in the blue wavelength range than at other wavelengths.

The output of the first photodetector is a scalar quantity representing the brightness as measured by the first photodetector, as determined by an equation similar to equation (2) above. Similarly, the output from the second photodetector is a scalar quantity representing the brightness as measured by the second photodetector, and is again given by an equation similar to equation (2) above. The correction factor determined, using the output of the second photodetector, is again a scalar quantity—and multiplying the measured output of the first photodetector by the correction factor compensates for the difference between the spectral response characteristic of the first photodetector and a reference spectral response characteristic (such as the response characteristic of the human eye).

The basic concept consists of performing a spectral correction to the output of a photodetector (for example a thin film photodetector), so as to be better matched spectrally to the output of some reference photodetector (for example the human eye). This invention addresses the requirement of adapting the colour content of an image. This is a different requirement to the prior art ALS described above since it is not necessary to determine the spectral characteristics of the incident illumination, but merely adjust the measured intensity to more closely replicate that which would be perceived by the human eye.

The invention is found to be particularly suitable for a photodetector whose QE varies exponentially (or approximately exponentially) with wavelength, or that is peaked at a particular wavelength.

A light sensor of the invention contains two (or more) photodetector elements whose outputs are measured separately. The first photodetector has a colour filter (for example a blue colour filter) placed upon it (termed the “colour photodetector”). The second photodiode has no colour filter over it, termed the “white photodetector”. The outputs from each photosensor are measured separately, denoted col and W respectively. The measured values of col and W are then combined to determine a correction that may be applied to the output W of the white photodetector to give a spectrally corrected measurement of light intensity. The measured output W of the white photodetector can then be corrected to give a spectrally corrected measurement of light intensity.

The method may also be generalised so as to combine the output of a “white photodetector” W with multiple “colour photodetector” outputs col₁,col₂ . . . col_{N}, with each colour detector being sensitive in a different wavelength range. In its most general form the invention combines these outputs according to some function Ψ(W,col₁,col₂ . . . col_{N}) to determine a correction that may be applied to the output W of the white photodetector to give a spectrally corrected measurement of light intensity. The measured output W of the white photodetector can then be corrected to give a spectrally corrected measurement of light intensity.

In one embodiment, the outputs from the two photodetector elements are subtracted to give a spectrally corrected measured light intensity X:

X=W−(μ×col)

Here μ is a pre-determined constant chosen to optimise the spectral compensation. The value of μ may depend for example of the relative sizes of the photodetector elements, the transmission of the colour filters and the spectral response of the photodetector element. (An analogous expression may be used if there are two or more coloured photodetectors.)

The basis of the method can be most easily understood by considering a specific example as follows; the application of the method to a thin film photodetector whose QE is shown in FIG. 7 and which is strongly peaked towards short wavelengths.

Since the photodetector is more sensitive to blue light than to red light, the “white photodetector” whose output is denoted by W will in general overestimate the contribution to the luminance (as perceived by the human eye) due to blue light.

This overestimation is corrected by subtracting a constant μ times the measured response in a photodetector having a blue colour filter placed over it whose output is denoted by B, i.e.

X=W−(μ×B)

In an alternative embodiment, the ratio of the outputs from the two photodetector elements is calculated N=col/W. The spectrally corrected measured light intensity F is then calculated as

F=W×g(N)

where g(N) is some pre determined function, for example a quadratic function.

The basis of the method can again be understood by considering the application of the method to a thin film photodetector whose QE is shown in FIG. 7:

Firstly consider illumination of the photodetector by a blue-rich light source. Since the photodetector is relatively sensitive to blue light, the “white photodetector” will in general perceive the light source to be brighter than would be perceived by the human eye. In this case also, a relatively high proportion of the incident illumination will be detected by the “blue photodetector”, i.e. the ratio N=B/W will be relatively large.

Secondly consider illumination of the photodetector by a red-rich light source. Since in this case the photodetector is relatively insensitive to red light, the “white photodetector” will in general perceive the light source to be less bright than would be perceived by the human eye. In this case also, a relatively low proportion of the incident illumination will be detected by the “blue photodetector”, i.e. the ratio N=B/W will be relatively small.

There thus exists a connection between the evaluated value of N (the ratio of the outputs of the “blue photodetector” and “white photodetector” and whether the “white photodetector” underestimates or over estimates the brightness of the incident illumination relative to as is perceived by the human eye. By appropriately mapping this relationship to some judiciously chosen function of N, g(N), spectral correction can be performed.

As a refinement to this method, the quantity N can be defined by N=B/κW where κ is a scaling constant. This may for example be applicable if the “blue photodetector” and “white photodetector” are of different sizes to one another.

There are three principal advantages of the method described in comparison to the standard technique using colour filters described in prior art.

Firstly the method described in general is able to perform spectral correction more accurately than the standard method described in the prior art of summing the output from one or more photodetectors with colour filters placed over them. For example for the second embodiment of the invention, calculation indicates that, for the thin film detector with a QE as shown in FIG. 7, and with judicious choice of coefficients for a quadratic fitting function g(N), the average value of the spectral mismatch coefficient f₁ for the light sources shown in FIG. 4 may be less than half of that obtained using the standard technique described in the prior art.

A second advantage is that the loss in sensitivity due to the use of colour filters is much less than for the standard technique. This is because in the “white photodetector” there are no absorption losses at all, and in the “blue photodetector” the filter used has a transmission pass band in the region where the photodetector is most sensitive.

This advantage is especially apparent in certain applications where it may not be necessary to perform spectral correction accurately at all light levels. In this case the “blue photodetector” can be made to have much smaller area than the “white photodetector”. Spectral correction can be successfully implemented at high light levels, whilst at lower light levels attempts to do spectral correction can be abandoned and the output be taken simply to be that of the “white photodetector”. In this implementation there is hardly any loss in sensitivity in comparison to the case where no spectral correction whatsoever is attempted.

A third advantage of the invention is that the correction algorithm is relatively simple, merely requiring a subtraction or the computation of a ratio N and some simple function thereof. Such a method is well suited to an AMLCD where the demands on module size and power consumption make it preferable for the digital processing power to be as small as possible.

At least one of the first photodetector and the second photodetector may have spectral characteristics that vary over its active area.

At least a first part of the active area of the first photodetector may be sensitive in the first wavelength range and at least a second, different part of the active area of the first photodetector may be sensitive in a wavelength range different from the first wavelength range

A second aspect of the present invention provides a light sensor comprising: a first photodetector sensitive in a first wavelength range; a second photodetector sensitive in a second wavelength range different from the first wavelength range and a third photodetector sensitive in a third wavelength range different from the first wavelength range and the second wavelength range; a storage means for storing a plurality of pre-determined corrections for compensating the output of the first photodetector for a difference between a spectral response characteristic of the first photodetector and a reference spectral response characteristic; and a processor for selecting one of the stored corrections, using a ratio of an output of the second photodetector to an output of the first photodetector and a ratio of an output of the third photodetector to the output of the first photodetector; wherein the first wavelength range substantially corresponds to a wavelength range of interest; wherein the second wavelength range is a part of the wavelength range of interest; and wherein the third wavelength range is another part of the wavelength range of interest.

The wavelength range of interest may be a visible wavelength range. It may correspond substantially to the visible spectrum—that is, cover the wavelength range from approximately 400 nm to approximately 700 nm.

### BRIEF DESCRIPTION OF DRAWINGS

Preferred embodiments of the present invention will now be described by way of illustrative example with reference to the accompanying drawings, in which:

FIG. 1 shows a prior art AMLCD with integrated ambient light sensor;

FIG. 2 shows a cross section of a typical AMLCD;

FIG. 3 shows the spectral transmission of red, green and blue filters as typically used in a colour AMLCD;

FIG. 4 shows the relative spectral output of a number of common and laboratory light sources;

FIG. 5 shows the absorption coefficient as a function of wavelength of crystalline silicon;

FIG. 6 shows the typical relative Quantum Efficiency of a bulk silicon photodetector as a function of wavelength;

FIG. 7 shows prior art: the typical relative QE of a thin film silicon photodetector as a function of wavelength;

FIG. 8 shows the CIE luminous efficiency curve which maps the relative sensitivity of the human eye as a function of wavelength;

FIG. 9 shows a display having a photodetector of the invention;

FIG. 10 shows the procedure required to obtain a scaling parameter μ according to a first embodiment of the invention;

FIG. 11 shows a second embodiment of the invention;

FIG. 12 shows the procedure required to obtain the scaling parameters μ₁, μ₂, μ₃ . . . according to a modification of the first embodiment of the invention;

FIG. 13 shows a third embodiment of the invention;

FIG. 14 shows a further embodiment of the invention;

FIG. 15 shows the procedure required to find the coefficients of the function g(N) according to the third embodiment;

FIG. 16 shows an example of a function g(N) according to the third embodiment of the invention;

FIG. 17 shows a further embodiment of the invention;

FIG. 18 shows a seventh embodiment of the invention

FIG. 19 shows the colour photodetection element 502 of the seventh embodiment of the invention

FIG. 20 shows an eighth embodiment of the invention

FIG. 21 shows the colour photodetection element 512 of the eighth embodiment of the invention; and

FIG. 22 shows a ninth embodiment of the invention.

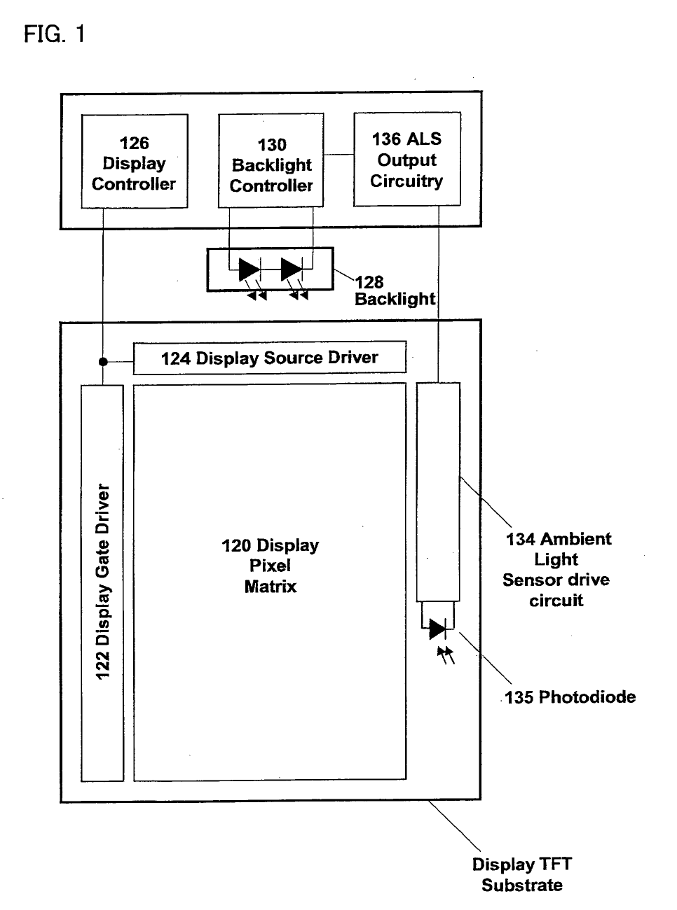

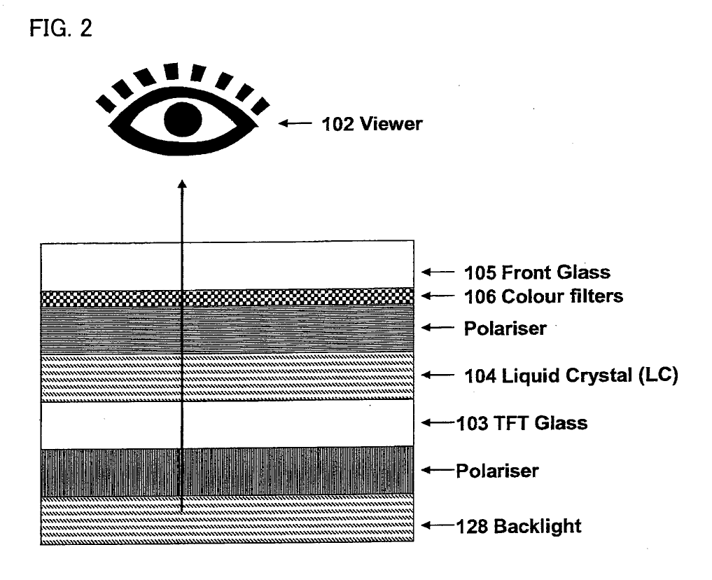

### BEST MODE FOR CARRYING OUT THE INVENTION

The invention will be described with reference to a light sensor used in an ALS system of a display. The light sensor of the invention is not, however, limited to this application.

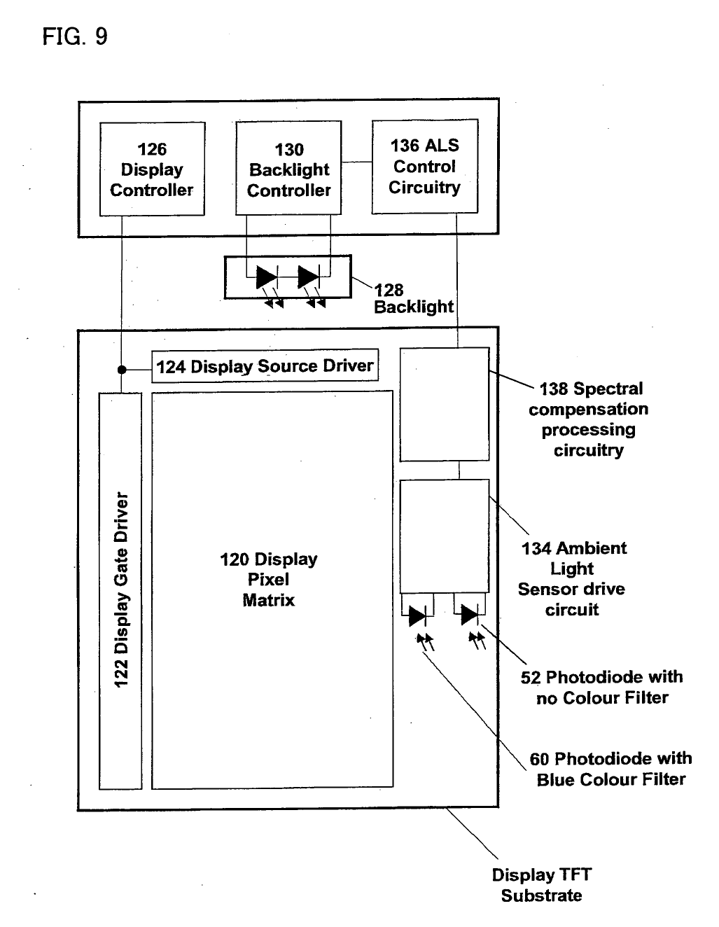

FIG. 9 shows a light sensor of the present invention. In FIG. 9 the photodetector constitutes an Ambient Light Sensor in an AMLCD display, but a photodetector of the invention is not limited to use as an ALS in a display, nor to use with an AMLCD display. Typically, the AMLCD device of FIG. 9 may itself be used in a number of products, such as a mobile phone or PDA.

The AMLCD consists of the following essential elements, as shown in FIG. 9:
the display pixel matrix 120 (where the image is displayed);
display gate driver 122;
display source driver 124;
display controller 126;
a backlight 128;
a backlight controller 130; and
an Ambient Light Sensor (ALS).

The Ambient Light Sensor consists of two photodetectors, in this embodiment thin-film photodiodes, the first photodetector 52 having no colour filter upon it and the second 60 having a colour filter, in this embodiment a blue filter, placed between its photosensitive region and the direction of the incoming light to be detected.

The ambient light sensor comprises the further following elements:
An Ambient Light Sensor drive circuit 134 for driving the photodetectors 52, 60 and for detecting the light levels as measured by the white and colour photodetectors, W and col₁ respectively (this may be, for example, one of the possible implementations of detection circuitry described in prior art);
ALS control circuitry 136; and
spectral compensation processing circuitry 138.

The spectral compensation processing circuitry 138 acts in use as a processor for processing the outputs of the two light sensors to give a spectrally-corrected measure of light intensity. In a first embodiment the processing circuitry evaluates (step 202) the value of parameter X, the quantity W−μ×col₁. The circuit 138 may do this through a simple computer program operated by a digital processor.

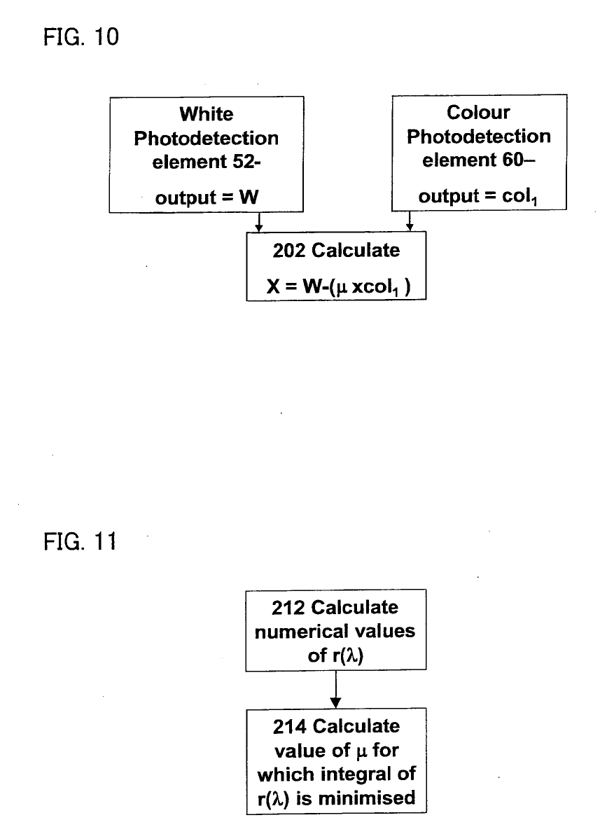

In this embodiment spectral compensation is performed by the following method, shown in FIG. 10:
Measure the outputs col₁ and W separately from each photosensor 52, 60;
Calculate X=W−μ×col₁ (step 202).

The quantity X is then representative of the spectrally corrected light level. The value of the scaling constant μ will be dependent on the spectral response characteristic of the sensor and the colour filter. A possible method for calculating an appropriate value of μ is as follows, shown FIG. 11:
For a sensor element having quantum efficiency function Q(λ) and for a colour filter having transmission f(λ) calculate (step 212) the numerical values of the function: r(λ)=Q(λ)[1−μ×f(λ)]−V(λ)
Determine (step 214) the scalar value of μ for which the integral of r(λ) over the range of wavelengths of interest is minimised. This corresponds to determining the value of μ for which the effective QE of the compensated sensor element most closely matches the luminous efficiency function.

It will be apparent to one skilled in the art that there are many other possible methods for calculating a suitable value of μ.

It will further be apparent to one skilled in the art that by suitable choice of colour filter transmission characteristic and parameter μ that the spectrally corrected output can be matched to functions of wavelength other than the luminous efficiency function V(λ) of the human eye.

The advantages of this method of spectral compensation are the quality of the spectral correction that can be achieved and the relatively low loss of detector sensitivity due to the need to perform spectral correction.

The operation of the AMLCD device of FIG. 9 is described as follows:
The display pixel matrix operates to display images in the normal way, being driven by the gate and source drive circuitry and being controlled by the display controller circuitry. The light source for the display is typically an array of white LEDs which are driven and controlled by backlight control circuitry.
The Ambient Light Sensor (ALS) detects the spectrally compensated ambient light level incident upon the photodiodes which in turn provides, at periodic intervals of time, a digitised output to the ALS controller.
The ALS controller then communicates with the backlight controller circuit which in turn modulates the intensity of the backlight according to the ALS output. Consequently this arrangement is capable on adjusting the brightness of the image displayed according to the ambient lighting intensity.

The advantages of this are that controlling the image brightness according to the ambient lighting conditions facilitates both an improved user experience and also an overall lower system power consumption, since under many ambient lightning conditions the backlight intensity can be reduced or the backlight turned off completely.

An advantage of spectrally correcting the output of the ambient light sensor to better match that of the eye is that the image brightness can be controlled more closely in proportion to the ambient light level as determined by the eye. This facilitates improved user experience.

A further important advantage is that the Ambient Light Sensor circuitry (comprising the photodiodes, the measurement circuitry and the ADC) can all be integrated onto the display TFT substrate monolithically. The spectral correction method described has the advantage of requiring only a small amount of processing capability. This all has considerable benefits for the size, cost and ease of manufacture of the AMLCD product.

An optional implementation of the first embodiment, which may be applied where the display pixel matrix 120 of the AMLCD includes colour filters, is to use one or more colour filters of the AMLCD as the colour filter of the second photodetector 60. For example, rather than providing the second photodetector 60 with a blue colour filter as described above, it would be possible to position the second photodetector 60 such that ambient light incident on the active area of the second photodetector 60 must pass through a blue colour filter of the AMLCD—ie, so that a blue colour filter of the AMLCD is in the optical path of ambient light to the active area of the second photodetector 60. This avoids the need to provide a separate colour filter for the second photodetector 60.

In this implementation, it is preferable that the first photodetector 52 is positioned such that ambient light incident on the active area of the first photodetector 52 also passes through the AMLCD, although not through any colour filters of the AMLCD. This ensures that effects such as, for example, absorption of light by the liquid crystal layer of the AMLCD or by the substrates of the AMLCD apply to the light incident on both the first photodetector 52 and the second photodetector 60—so that any difference between light incident on the first photodetector 52 and light incident on the second photodetector 60 arises from the blue colour filter in the optical path to the second photodetector 60.

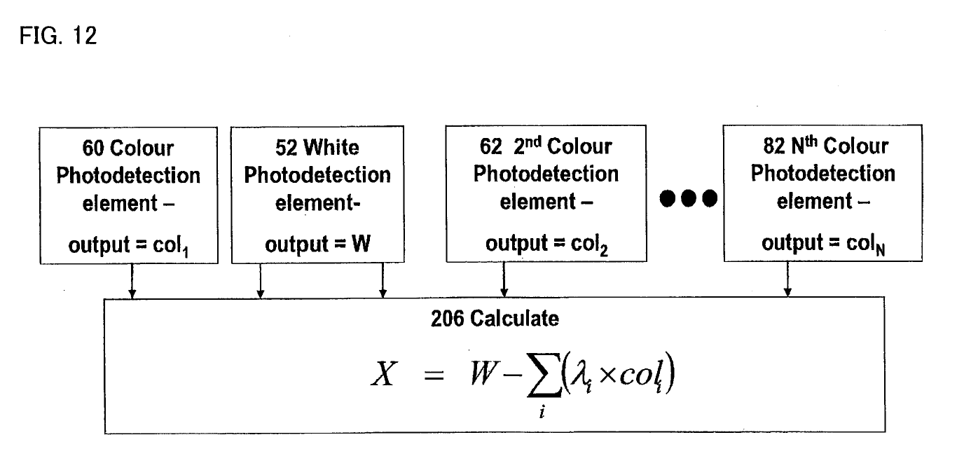

A second embodiment is shown in FIG. 12. This and the subsequent embodiments are identical to the first embodiment, except for the construction of the light sensor and the operation of the spectral compensation processing circuit 138. Description of components of the display that are unchanged from the first embodiment is omitted.

The second embodiment has a light sensor comprising the following elements:
A plurality of colour photodetection elements 60, 62 . . . 82 for example photodiodes, each having a colour filter of different spectral characteristics located between its photosensitive region and the direction of the incoming illumination to be detected;
A white photodetection element 52, for example a photodiode having no colour filter;
A means for detecting the light levels as measured by the white and colour photodetection elements, W and col₁, col₂ . . . col_{N} respectively.

The spectral compensation circuit 138 consists of the following:
A means 206 for using the outputs col₁, col₂ . . . col_{N} of the colour photodetectors to correct the output W of the white photodetector, for example by evaluating the quantity

$$X = W - {\sum }_{i} ( {μ}_{i} \times {col}_{i} ) ;$$

this may be done, for example, by a simple computer program operating in Digital Signal Processing.

The system operates so as to:
Measure the outputs col₁, col₂ and W separately from each photosensor
Calculate X.

The quantity X is then representative of the spectrally corrected light level.

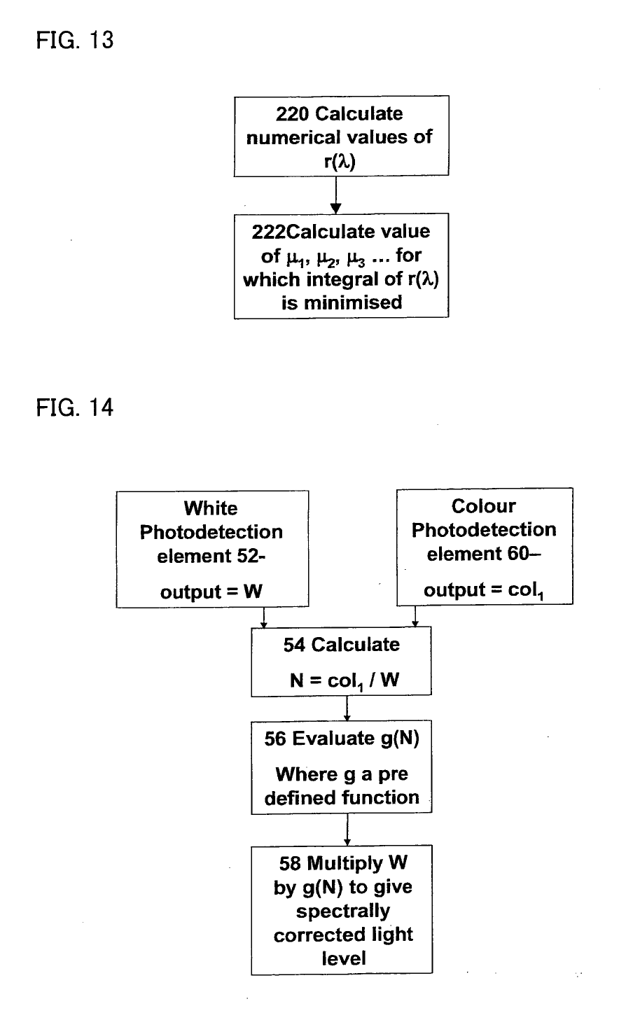

A possible method for calculating values of the scaling parameters μᵢ is as follows, shown schematically in FIG. 13:
For a photodetector element having quantum efficiency function Q(λ) and for a colour filters having transmission f₁(λ), f₂(λ) . . . calculate (220) the numerical values of the function

r(λ)=Q(λ)[1−λ×f₁(λ)−μ₂×f₂(λ)− . . . ]−V(λ)
Determine the scalar values of μ₁, μ₂for which the integral of r(λ) over the range of wavelengths of interest is minimised (222). This corresponds to determining the values of μᵢ for which the effective QE of the compensated sensor element most closely matches the luminous efficiency function.

An advantage of this embodiment is that a correction algorithm can be defined to make use of the increased amount of spectral information provided by having multiple colour photosensor elements, thus making it possible to improve the accuracy of the spectral correction performed. The method is also well suited to detection of light sources which may be strongly peaked at one or more wavelengths.

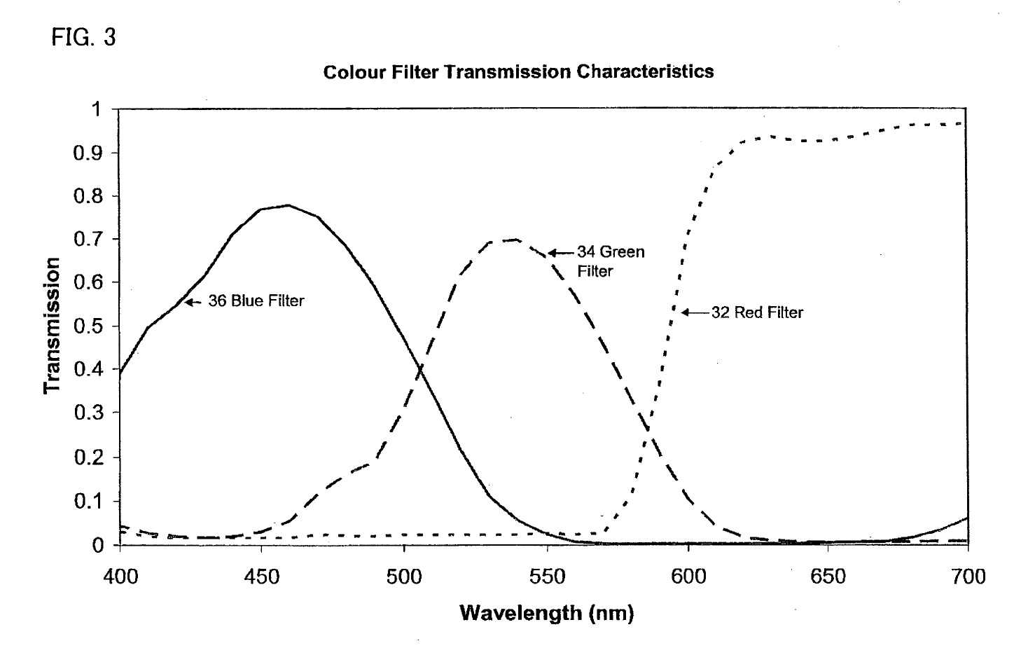

A third embodiment is illustrated in FIG. 14. In this embodiment a light sensor comprises the following elements:
A colour photodetection element 60 which has a colour filter, for example as the blue colour filter 36 shown FIG. 3, located between its photosensitive region and the direction of the incoming illumination to be detected.
A white photodetection element 52 having no colour filter.
A means for detecting the light levels as measured by the white and colour photodetection elements, W and col₁ respectively.

In this embodiment the spectral compensation processing circuit 138 consists of:
A means 54 for evaluating the value of the parameter N, the ratio col₁/W
A means 56 for calculating the value of the function g(N) for the measured value of the parameter N, for example according to a simple computer program, where g is some simple function of the variable N, for example a polynomial.
A means 58 for calculating the value (for the measured value of N) of g(N) multiplied by W, a quantity which represents the spectrally corrected ambient light level.
The means 54, 56, 58 may be separate, or two or more of the means 54, 56, 58 may be embodied as a single component. The system operates so as to:
Measure the outputs col₁ and W separately from each photosensor;
Calculate the value of N, the ratio of col₁ and W—the calculated value is denoted by N_{D};
Evaluate g(N_{D}), by putting the determined N_{D} into a known function g(N), to give a scalar value g(N_{D})
Multiply the output of the white photodetection element by g(N_{D}).

The result, W g(N_{D}), is then representative of the spectrally corrected light level.

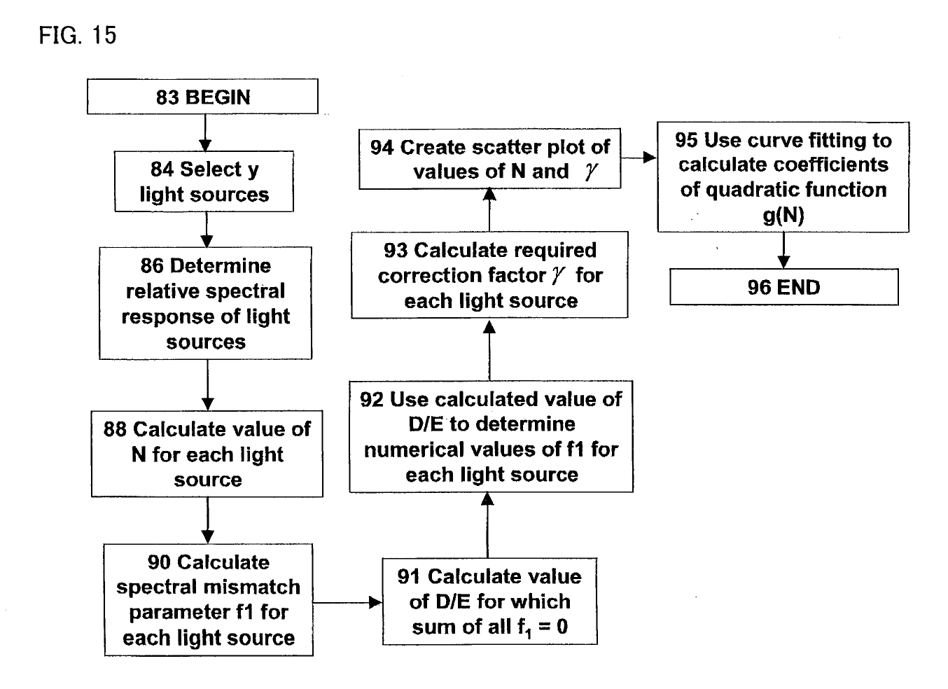

In one embodiment g(N) is a quadratic function in N—ie, g(N)=g₁N²+g₂N+g₃. A possible method for calculating values of the coefficients of the quadratic function used in this embodiment is by using the three part procedure described as follows and shown schematically in FIG. 15. The evaluation of the various mathematical functions can be performed by standard well known numerical techniques or by simple coding using a standard commercial spreadsheet software (e.g. Microsoft® Excel).

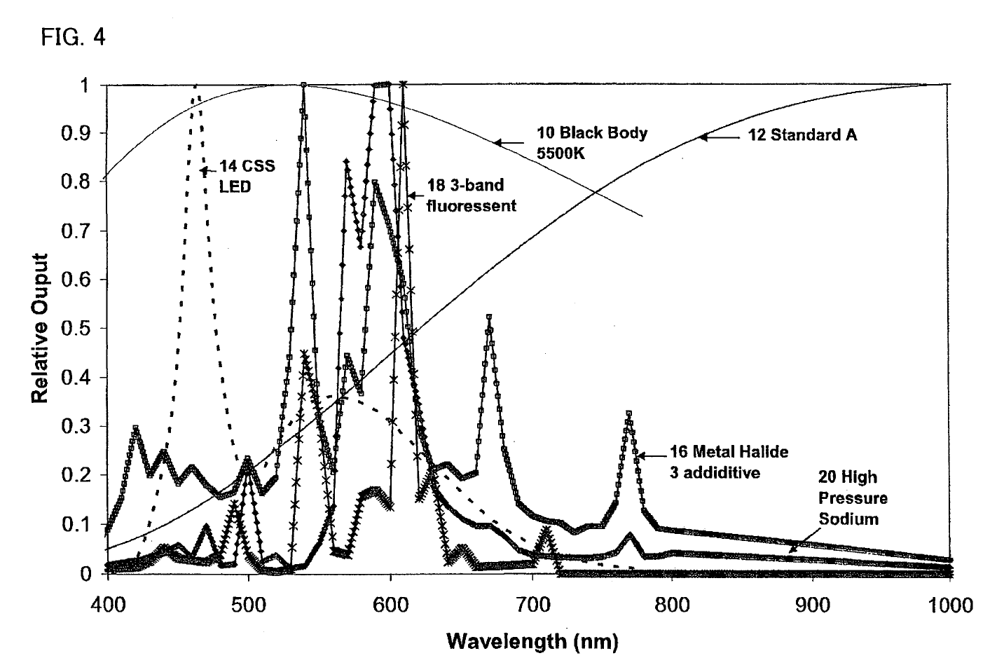

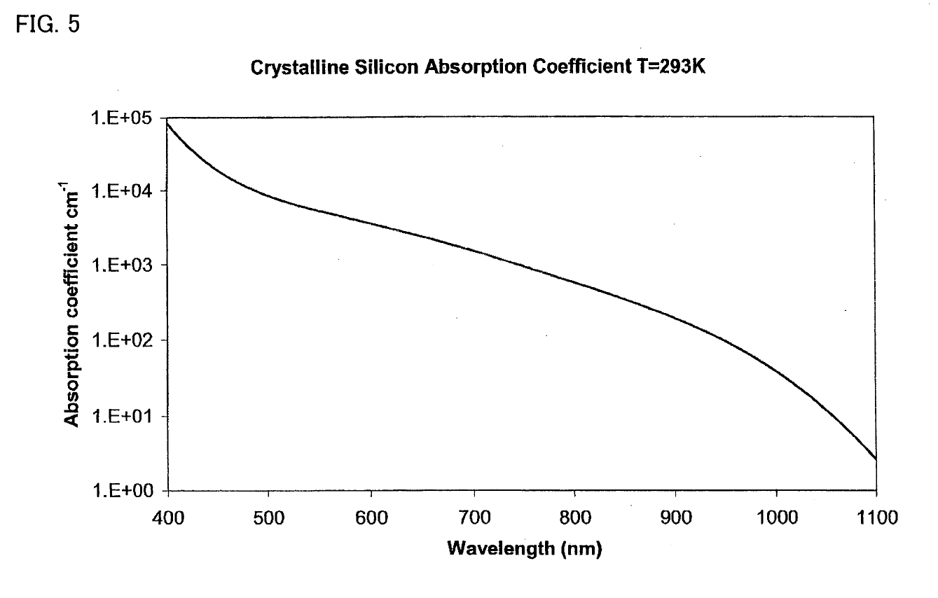

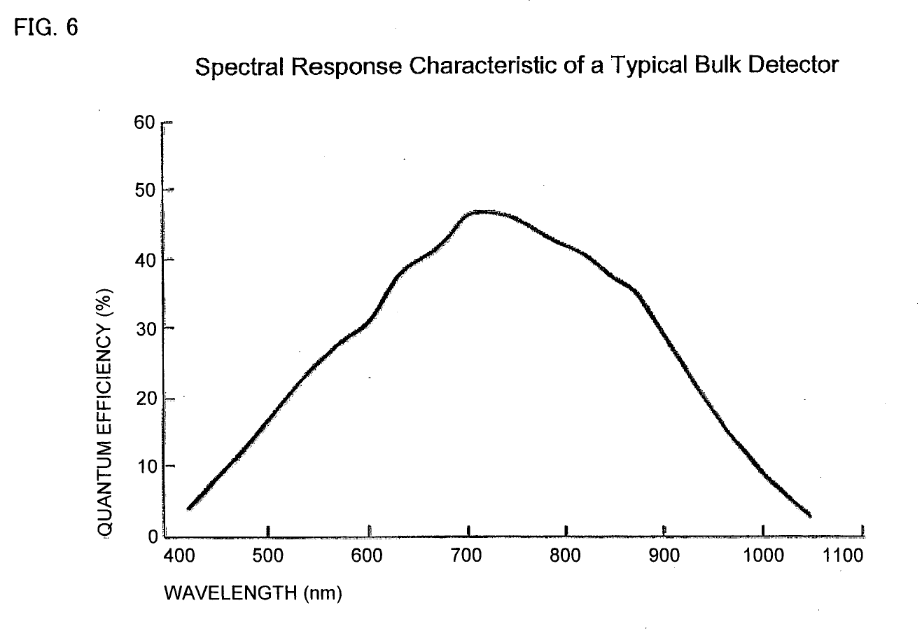

PART 1
STEP1 Begin procedure at 83 to obtain coefficients.
STEP2 Choose at 84 a selection of (at least three) light sources that are of interest for the light sensor requiring spectral compensation. We will denote the number of light sources used by the integer y. For example all of the light sources whose response characteristics are shown FIG. 4 could be chosen.
STEP 3 Determine at 86 (e.g. from published data in prior art) the relative spectral response of the y light sources, for example as shown FIG. 4.
STEP 4 For each light source calculate at 88 the theoretical value of the parameter N corresponding to the relative response of the colour and white photosensor given by

$$N = \frac{\int Q ( λ ) I ( λ ) f ( λ ) d λ}{\int Q ( λ ) I ( λ ) d λ} \qquad ( 5 )$$

In evaluating this expression both integrals should be performed over the range of wavelengths for which the human eye is sensitive, e.g. for which V(λ)is non-zero.

Performing this operation for each light source will give a value of N for each of the y light sources.

PART 2
STEP 5 Using expressions (1), (2) and (3) as defined in the prior art section, calculate at 90 a value of the spectral mismatch parameter f₁ as a function of the ratio D/E, for each of the y different light sources.
The y different values can be denoted f₁{1}, f₁{2} . . . f₁{y}
STEP 6 Calculate at 91 the value of the ratio of scaling parameters D/E for which the mean value of f₁ averaged over all light sources is equal to zero.
To do this find the value of D/E which solves the equation

f₁{1}+f₁{2}+ . . . f₁{y}=0

This scaling operation is equivalent to choosing the “gain” of the detector so that the average spectral mismatch parameter over all the chosen light sources is equal to zero
STEP 7 Substitute at 92 the value of D/E calculated above into the expressions for f₁{1}, f₁{2} . . . f₁{y} to obtain the numerical values of these functions, one for each light source.
STEP 8 Calculate at 93 the required correction factor for each light source γ=P_{det}/P_{eye}. This is done most simply from the already calculated values of f₁ and re-arranging equation (3).

From Parts 1 and 2, for each of the chosen light sources a numerical value of parameters N and γ has been created. The parameter N corresponds to the ratio of outputs from the coloured and white photosensor elements. The parameter γ corresponds to the required spectral correction that needs to be applied to the measured output of the white photodetector element for the chosen light source.

PART 3
STEP 9 Create at 94 a scatter plot having a total of y data points, whose values are (γ,N), the x datum corresponding to the values of γ and the y data points corresponding to the values of N calculated for each light source.
STEP 10 By means of linear regression or other standard curve fitting techniques, calculate at 95 the coefficients of the best fit quadratic function γ=g(N)=g₁N²+g₂N+g₃.
STEP 11 End procedure at 96 to obtain coefficients. The quadratic function used in the correction algorithm has now been computed.

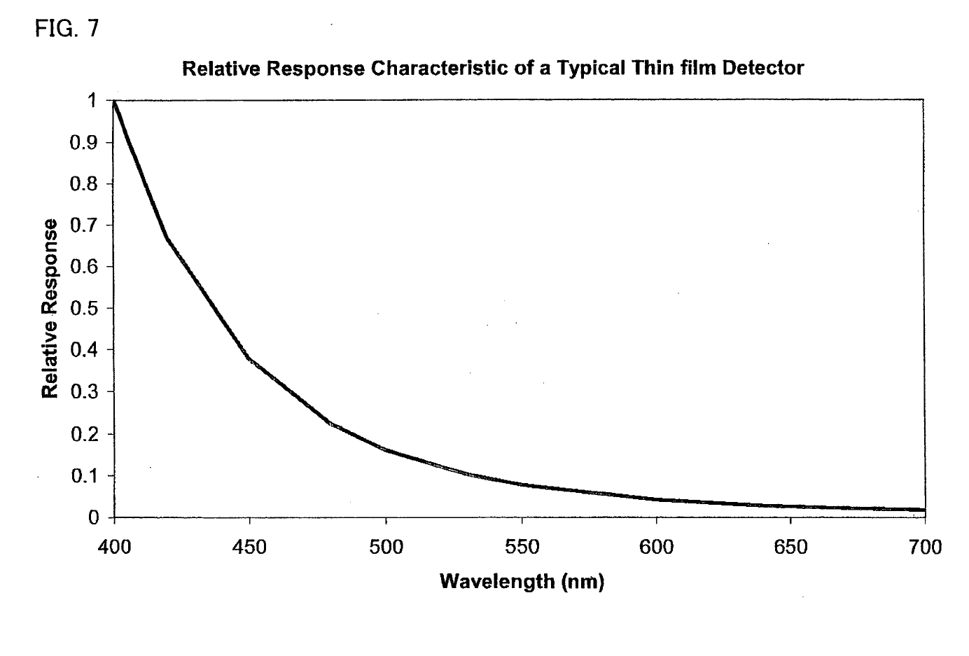

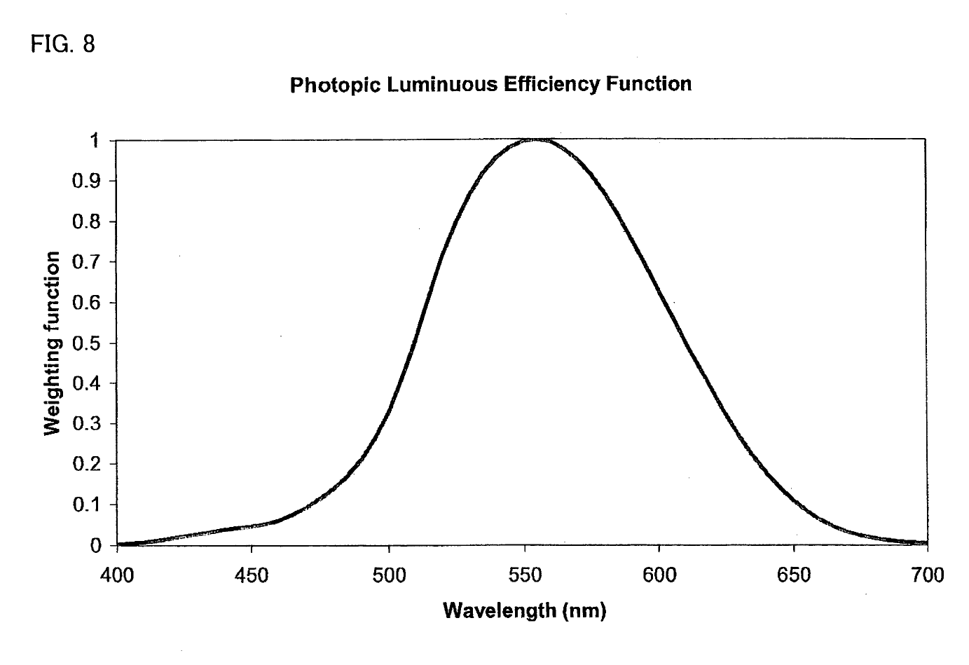

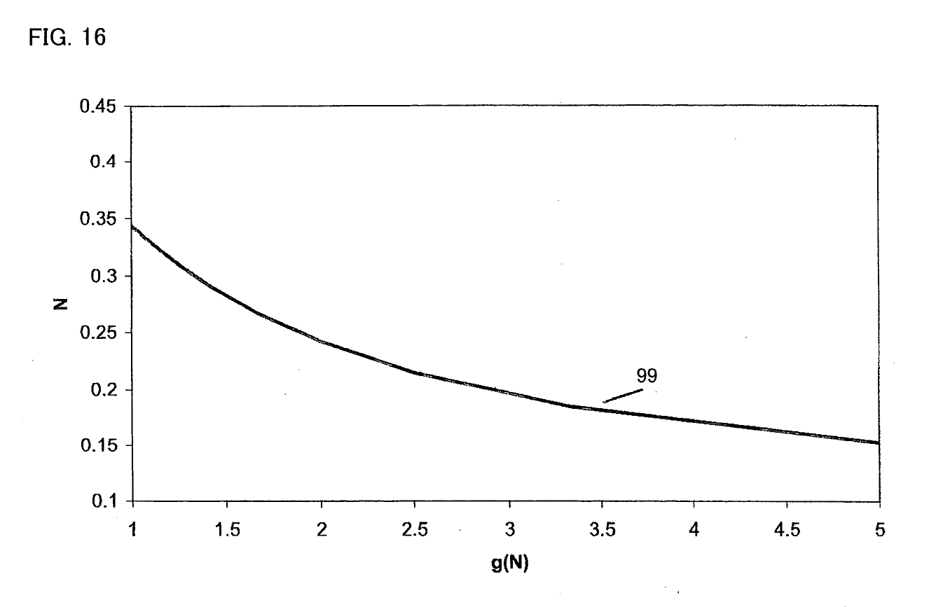

An example quadratic function γ=g(N)=g₁N²+g₂N+g₃, calculated for a white photodetection element 52 whose spectral response characteristic is shown FIG. 7, and for a colour photodetection element 60 with the blue colour filter having the response 36 shown FIG. 3 is shown 99 in FIG. 16.

It will be apparent to one skilled in the art that alternative fitting functions for the quantity g(N) are also possible. For example a linear relationship, a higher order polynomial or an exponential could all be used with best fit coefficients chosen according to the computed numerical data points (γ,N) being fitted to.

It will also be apparent to one skilled in the art that a fitting function g(N) may be valid only over a certain range. The definition of the function g(N) may therefore include a range of validity in addition to the numerical function.

The advantages of this embodiment are in its simplicity (once that the coefficients of g(N) are defined, the output of the white photodetector may be corrected without further calculation of the function g(N)) (the definition of which may be stored or hard-programmed in memory so that the value of g(N) for each measured value of col/W may be readily evaluated), the quality of the spectral correction that can be achieved and the relatively low loss of detector sensitivity due to implementing the described method for spectral correction.

A fourth embodiment corresponds to the first embodiment, except that the colour photodetection element 60 is of a different width to the white photodetection element 52. If the active sensing area of the colour photodetection element 60 is a factor κ of the size of the active sensing area of the white photodetection element, the parameter μ as calculated for identically sized white and coloured photodetection elements must be multiplied by an additional of factor 1/κ, giving X=W−μ/κx col₁.

Similarly, if the active sensing area of the colour photodetection element 60 is a factor κ of the size of the active sensing area of the white photodetection element, the procedure for calculating the function g(N) is modified in a fifth embodiment by the inclusion of an additional factor κ in the denominator of equation (5), but is otherwise identical.

An advantage of the fourth and fifth embodiments is that loss in sensitivity compared to the case where no spectral correction is performed can be made very small in the case where κ is made small. In certain circumstances it may not be necessary to perform spectral compensation at all the light levels over which the detector is sensitive. For example in a light sensor that is sensitive over a range of operation comprising 5 decades of different illumination levels, it may only be necessary to spectrally compensate over the highest four decades of sensitivity. In this case κ can be made small—so that the colour photodetector is physically small and most of the layout area of the sensor will be taken up by the white photosensor element, thus maximising sensitivity.

The first to fifth embodiments are directed to compensating for the difference between the spectral response characteristic of the sensor and a desired spectral response characteristic (such as the spectral response characteristic of the human eye). As noted in the introduction, however, the spectral characteristics of the illuminating light will depend on the source of the illuminating light, and a further embodiment of the invention addresses this. The basic principle of this further embodiment is to use the fact that some light sources might have specific spectral “signatures”, which can be recognised from a combination of the ratios N₁=col₁/W, N₂=col₂/W etc. For example a sodium street light might give a high output in a “yellow” photodiode but a low output in a “blue” photodiode. In principle by determining the values of N₁, N₂, etc. it might be possible to recognise that the light source is a sodium light and apply spectral correction accordingly.

The principle of the further embodiment is to measure the values of N₁, N₂ etc and then compare these with values stored into a look up table (LUT). The look up table will have entries for N₁, N₂ etc corresponding to values expected for a plurality of different types of light sources. If the measured values of N₁, N₂, . . . etc. were close to one of the LUT entries, the system would “recognise” the light source as being a sodium light (for example) and then apply a pre-programmed correction factor theta read from the LUT. The corrected light level is then just W times theta.

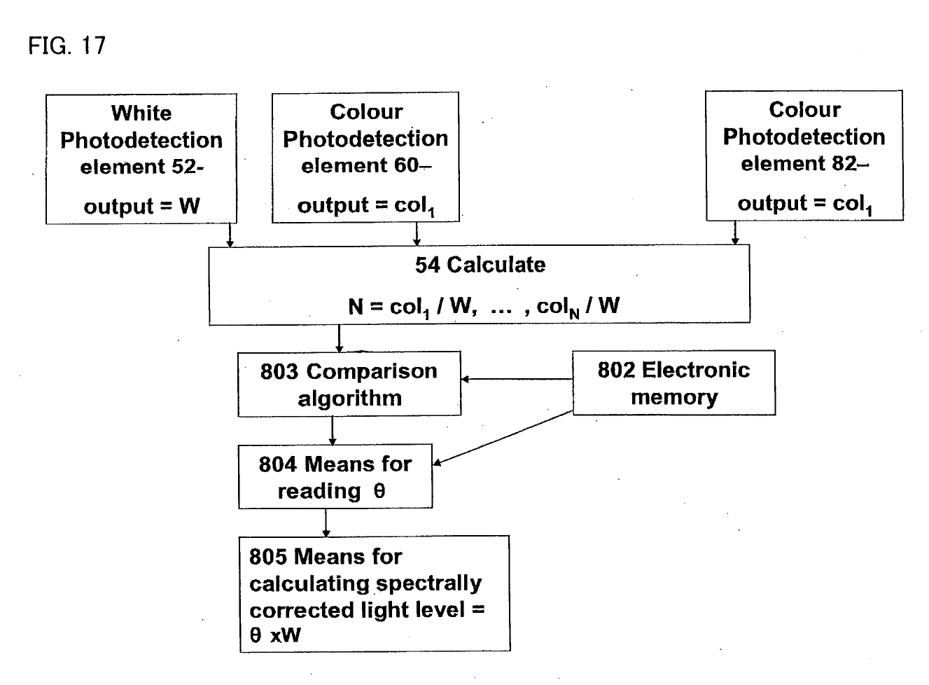

A sixth embodiment is shown in FIG. 17. In this embodiment a light sensor comprises the following elements:
A plurality of colour photodetection elements 60 . . . 82, for example photodiodes, each having a colour filter of different spectral characteristics located between its photosensitive region and the direction of the incoming illumination to be detected;
A white photodetection element 52, for example a photodiode having no colour filter;
A means for detecting the light levels as measured by the white and colour photodetection elements, W and col₁, col₂, . . . col_{N} respectively.

The spectral compensation processing circuit of FIG. 9 consists, in the embodiment of FIG. 17, of the following:
A means 54 for evaluating the value of parameter Nᵢ, the ratio colᵢ/W, for the output of each colour detection element, e.g. N₁, N₂, . . . N_{N};
An array of electronic memory 802, for example SRAM, pre-programmed with a look up table (LUT) of spectral correction data—containing the values of N₁, N₂, . . . N_{N} for a plurality of different types of light source;
A means 803, for comparing the measured values of N₁, N₂, . . . N_{N} with pre-programmed values of the same parameters in electronic memory, and selecting a set of pre-programmed values most closely corresponding with the measured values;
A means 804, for example a processor operating a simple computer program, for reading a value Θ from the electronic memory which corresponds to the selected set of N₁, N₂, . . . N_{N};
A means 805 for calculating a quantity which represents the spectrally corrected ambient light level equal to Θ×W;
The means 54, 803, 804, 805 may be separate, or two or more of the means may be combined.

The system operates so as to:
Measure the outputs col₁ and W separately from each photosensor;
Calculate the ratio of col₁ and W, the ratio of col₂ and W . . . the ratio of col_{N} and W. These parameters are denoted N₁, N₂, . . . N_{N};
Compare the values of N₁, N₂, . . . N_{N} with a look up table in electronic memory 802;
Select the set of values N₁, N₂, . . . N_{N} in memory most closely corresponding to the measured values of the same parameters. This could be done for example by finding the values for which the sum of the squares is minimised, i.e.

$${\sum }_{i = 1}^{N} {( {N}_{i} ( memory ) - {N}_{i} ( measured ) )}^{2}$$

is minimised;
Reads from the electronic memory 802 a value Θ which corresponds to the selected set of N₁, N₂, . . . N_{N};
Multiply the output of the white photodetection element by Θ.

The memory array is pre-programmed as follows:
A number of light sources of interest are selected and their output spectra determined, for example the light sources having the spectra shown in FIG. 4;
The parameter N₁ is calculated for each of the light sources using the method described in steps 1-4 of the third embodiment;
The parameters N₂, N₃ . . . N_{N} are similarly calculated for each light source;
The required correction factor for each light source γ is then calculated using the method described in steps 5-8 of the third embodiment;
For each light source an entry is made in the memory LUT of the values N₁, N₂, . . . N_{N} and a corresponding value of Θ=γ.

The parameters N₁, N₂ etc may be determined by measurement, or they may be determined theoretically for a particular light source if the spectrum of the light source and the sensor response characteristics are known.

An advantage of this embodiment is that the spectral correction can be performed based on the recognition of a specific spectral signature for a lighting condition of interest. The spectral signature can be determined by recognition of the value of the ratio N.

It will be apparent to one skilled in the art that it is possible to devise systems that combine the spectral compensation methods of the third and sixth embodiments, for example employing the method of the third embodiment as a default, and the method of the sixth embodiment in the case where specific spectral signatures are recognised. For example if the light source was recognised, e.g. as sodium light, a value of Θ would be read and correction performed, or if instead the obtained values of N₁, N₂ etc . . . were not close enough to any of the values stored in the LUT for successful recognition of a light source, the alternative method of determining g(N) could be used.

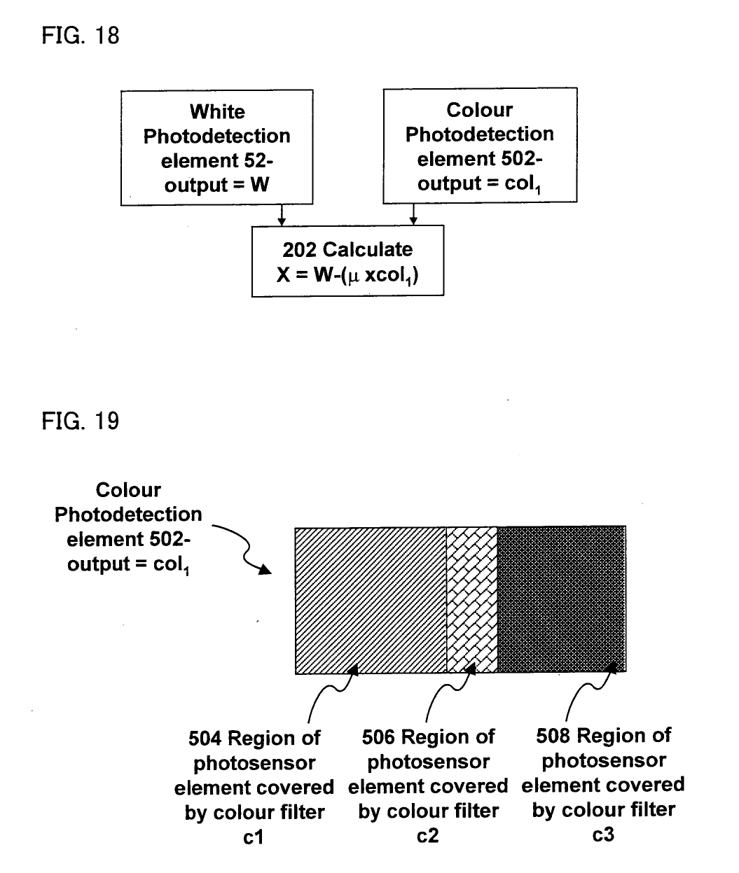

A seventh embodiment of the invention is shown in FIGS. 18 and 19.

The seventh embodiment has a light sensor comprising the following elements:
A colour photodetection elements 502 for example a photodiode, having multiple colour filters of different spectral characteristics located over different areas of the photosensitive region, placed between the photosensitive region and the direction of the incoming illumination to be detected. The different colour filters may cover different proportions of the photosensitive region. An example arrangement for this colour photodetection element 502 is shown FIG. 19, with photosensitive regions 504, 506 and 508 being covered by colour filter c1, colour filter c2 and colour filter c3 respectively. The colour filters c1, c2 and c3 do not have the same spectral characteristics as one another, and preferably all have different spectral characteristics from one another. (Three colour filters c1-c3 are provided in this embodiment, but the invention is not limited to this and fewer than, or more that, three colour filters may be provided.)
A white photodetection element 52, for example a photodiode having no colour filter;
A means for detecting the light levels as measured by the white and colour photodetection elements, W and col₁ respectively.

In this embodiment, the spectral compensation circuit (eg, the spectral compensation circuit 138 of FIG. 9) consists of the following:
A means 202 for using the output col₁ of the colour photodetector to correct the output W of the white photodetector, for example by evaluating the quantity X=W−μ×col₁; this may be done, for example, by a simple computer program operating in Digital Signal Processing.

The system operates so as to:
Measure the outputs col₁ and W separately from each photosensor.
Calculate X.

The quantity X is then representative of the spectrally corrected light level.

A possible method for calculating values of the scaling parameter μ is as has already been specified in the description of the first embodiment.

This embodiment combines the advantages of the first and the second embodiments; the use of multiple colour filters over the colour photodetection element 502 facilitates a high accuracy of the quality of spectral compensation that can be achieved, whilst the means for performing processing 202 is only required to perform a single subtraction.

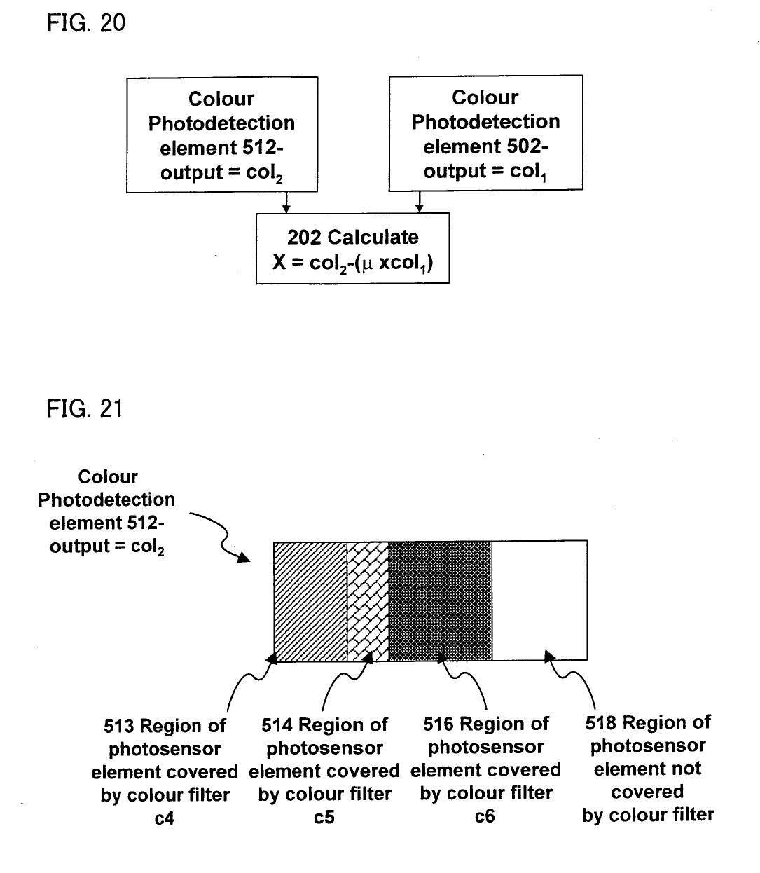

An eighth embodiment of the invention is shown in FIGS. 20 and 21.

The eighth embodiment has a light sensor comprising the following elements:
A first colour photodetection element 502 for example a photodiode, having multiple colour filters of different spectral characteristics located over different areas of the photosensitive region, placed between the photosensitive region and the direction of the incoming illumination to be detected. The first colour photodetection element 502 may be a photodetection element as shown FIG. 19, in which different colour filters may cover different proportions of the photosensitive region of the element.
A second colour photodetection element 512, for example a photodiode having multiple colour filters of different spectral characteristics located over different areas of the photosensitive region, placed between the photosensitive region and the direction of the incoming illumination to be detected. This photodetection element 512 may also contain a region having no colour filter placed over it. An example arrangement for this colour photodetection element 512 is shown FIG. 21, with photosensitive regions 513, 514 and 516 being covered by colour filter c4, c5 and c6 respectively, and photosensitive region 518 not being covered by a colour filter. The colour filters c4, c5 and c6 do not have the same spectral characteristics as one another, and preferably all have different spectral characteristics from one another. (Three colour filters c4-c6 are provided in this embodiment, but the invention is not limited to this and fewer than, or more that, three colour filters may be provided.)
A means for detecting the light levels as measured by the first and second colour photodetection elements, col₁and col₂ respectively.

In this embodiment, the spectral compensation circuit (for example the spectral compensation circuit 138 of FIG. 9) consists of the following:
A means 206 for using the output col₁ of the first colour photodetector to correct the output col₂ of the second colour photodetector, for example by evaluating the quantity X=col₂−μ×col₁; this may be done, for example, by a simple computer program operating in Digital Signal Processing.

The system operates so as to:
Measure the outputs col₁ and col₂ separately from each photosensor.
Calculate X.

The quantity X is then representative of the spectrally corrected light level.

A possible method for calculating values of the scaling parameter μ is as has already been specified in the description of the first embodiment.

This embodiment has the advantages of the seventh embodiment, with the additional advantage that the accuracy of the spectral compensation may be improved by a suitable choice of the spectral characteristics of the colour filters c4, c5 and c6 and the proportion of the photosensitive area covered by each of them.

In this embodiment, the second colour photodetection element 512 corresponds generally to the “white” photodetection element of earlier embodiments, by virtue of the photosensitive region 518 this is not covered by a colour filter.

In this embodiment, the choice of the spectral characteristics of the colour filters c1 . . . c6 and their relative areas on the photodetector will be dependent predominantly on the spectral characteristics of the photodetector active area, and the filter characteristics that are conveniently available. For example, a possible implementation of this embodiment could involve the use of a combination of no colour filter (white) and green colour filter over the second photosensor element such that the output of the second photodetector col₂ is well matched to the output of the eye for the wavelengths around where the eye is most sensitive, and the use of a combination of red and blue colour filters over the first photosensor element, chosen such that its output col₁ is tuned to make the quantity col₂−μ×col₁ spectrally well matched to the eye, the subtracted quantity μ×col₁ having the effect of reducing the contribution from wavelengths where the eye is relatively insensitive compared to the photodetector element.

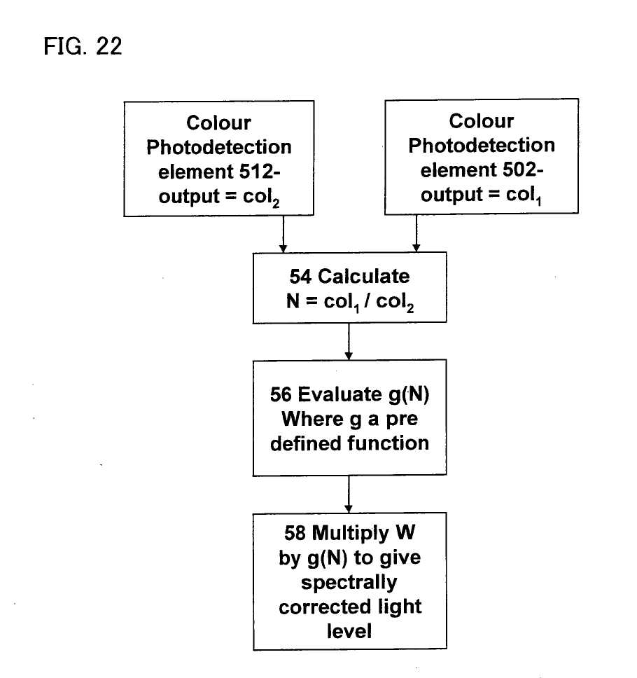

A ninth embodiment of the invention is, shown in FIG. 22.

The ninth embodiment is generally similar to the third embodiment, except that the white photodetection element described in the third embodiment is replaced by the second colour photodetection element 512 as described in the eighth embodiment, and the colour photodetection element described in the third embodiment is replaced by the first colour photodetection element 502 as described in the eighth embodiment.

The operation of this embodiment and the method for defining the function g is then as has already been described for the third embodiment

This embodiment has the advantages of the third embodiment, with the additional advantage that the accuracy of the spectral compensation may be improved by suitable choices of the filter types used and the proportion of the photodiode areas which they cover.

In the embodiments described above it has been assumed that the colour photodetector(s) are identical to the white photodetector, apart from the overlying colour filter (and possibly apart from the size of their active sensing area). However, the colour photodetector(s) do not need to be identical to the white photodetector. The colour photodetector(s) and the white photodetector could be non-identical in the sense of having different constructions of sensor device but with the same spectral response characteristics (ignoring the effect of the colour filter)—for example a thin film photodiode and a photo-TFT would have the same spectral response characteristics.

Moreover, in principle the colour photodetector(s) and the white photodetector could have different spectral response characteristics if this was taken into account in the correction process (e.g. the invention could be implemented using one photodiode made from polysilicon and one made from amorphous silicon, and these could have different spectral response characteristics to one another).

In the embodiments described above the light sensor of the invention has been incorporated in a display, for example with the photodetectors provided on the display substrate. The invention may, however, be applied to any light sensor where it is desired to correct the output of the light sensor for a difference between the spectral response characteristic of a photodetector and a reference spectral response characteristic.

For any embodiment in which the invention is incorporated in a display having colour filters, the embodiment may be implemented by using colour filters of the display as colour filters for the colour photodetection elements as described for the first embodiment. For example, the second embodiment described above requires two or more colour photodetection elements of different spectral characteristics, and this may be implemented by positioning one photodetection element such that ambient light incident on its active area must pass through a first colour filter (eg a blue colour filter) of the display and positioning another photodetection element such that ambient light incident on its active area must pass through a second colour filter of the display having different spectral characteristics to the first colour filter (eg a green colour filter), so that the photodetection elements form first and second colour photodetection elements. If a further colour photodetection element were desired, it would be possible to position another photodetection element such that ambient light incident on its active area must pass through a third colour filter of the display having different spectral characteristics to the first and second colour filters (eg a red colour filter).

In principle, the eight and ninth embodiments may also be implemented by using colour filters of the display as colour filters for the colour photodetection elements, by positioning a photodetection element such that ambient light incident on one part of its active area must pass through a first colour filter and ambient light incident on another part of its active area must pass through a second colour filter of the display having different spectral characteristics to the first colour filter (and, if required, so that ambient light incident on a further part of its active area must pass through a third colour filter having different spectral characteristics to the first and second colour filters).

Embodiments implemented using colour filters of the display as colour filters for the colour photodetection elements are not limited to displays having red, green and blue colour filters, but may also be applied to displays having cyan, yellow and magenta colour filters.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

1. A light sensor comprising: a first photodetector sensitive in a first wavelength range; a second photodetector sensitive in a second wavelength range different from the first wavelength range; and a processor for determining, using the output of the second photodetector, a correction to the output of the first photodetector for compensating an output of the first photodetector for a difference between a spectral response characteristic of the first photodetector and a reference spectral response characteristic; wherein the first wavelength range substantially corresponds to a wavelength range of interest; and wherein the second wavelength range is a part of the wavelength range of interest.

2. A light sensor as claimed in claim 1 wherein the processor is adapted to apply the correction to the output of the first photodetector.

3. A light sensor as claimed in claim 1 wherein the reference spectral response characteristic is the spectral response characteristic of a human eye.

4. A light sensor as claimed in claim 1 wherein the wavelength range of interest is a visible wavelength range.

5. A light sensor as claimed in claim 4 wherein the first wavelength range substantially corresponds to the visible spectrum.

6. A light sensor as claimed in claim 4 wherein the second wavelength range is in a blue region of the visible spectrum.

7. A light sensor as claimed in claim 2 wherein the processor is adapted to correct the output of the first photodetector in a first range of output intensity from the first photodetector and is adapted not to correct the output of the first photodetector in a second range of output intensity from the first photodetector different from the first range of output intensity.

8. A light sensor as claimed in claim 2 wherein the processor is adapted to combine the output of the first photodetector and the output of the second photodetector.

9. A light sensor as claimed in claim 1 wherein the correction is to subtract a part of the output of the second photodetector from the output of the first photodetector.

10. A light sensor as claimed in claim 1 wherein the processor is adapted to determine a correction from the output of the first photodetector and the output of the second photodetector.

11. A light sensor as claimed in claim 10 wherein the correction is determined using a pre-determined function of a ratio of the output of the first photodetector to the output of the second photodetector.

12. A light sensor as claimed in claim 11 wherein the pre-determined function is a polynomial function of the ratio of the output of the first photodetector to the output of the second photodetector.

13. A light sensor as claimed in claim 1 wherein at least one of the first photodetector and the second photodetector has spectral characteristics that vary over its active area.

14. A light sensor as claimed in claim 13 wherein at least a first part of the active area of the first photodetector is sensitive in the first wavelength range and at least a second, different part of the active area of the first photodetector is sensitive in a wavelength range different from the first wavelength range.

15. A light sensor as claimed in claim 1 and further comprising a third photodetector sensitive in a third wavelength range different from the first wavelength range and from the second wavelength range, and wherein the processor is adapted to further use an output of the third photodetector in determining the correction to the output of the first photodetector for compensating the output of the first photodetector for a difference between the spectral response characteristic of the first photodetector and a reference spectral response characteristic.

16. A light sensor as claimed in claim 15 wherein the correction is to subtract a part of the output of the second photodetector and a part of the output of the third photodetector from the output of the first light sensor.

17. A light sensor as claimed in claim 1 wherein the processor is adapted to take account of a difference between an active area of the first photodetector and an active area of the second photodetector in determining the correction.

18. A light sensor comprising: a first photodetector sensitive in a first wavelength range; a second photodetector sensitive in a second wavelength range different from the first wavelength range and a third photodetector sensitive in a third wavelength range different from the first wavelength range and the second wavelength range; a storage means for storing a plurality of pre-determined corrections for compensating the output of the first photodetector for a difference between a spectral response characteristic of the first photodetector and a reference spectral response characteristic; and a processor for selecting one of the stored corrections, using a ratio of an output of the second photodetector to an output of the first photodetector and a ratio of an output of the third photodetector to the output of the first photodetector; wherein the first wavelength range substantially corresponds to a wavelength range of interest; wherein the second wavelength range is a part of the wavelength range of interest; and wherein the third wavelength range is another part of the wavelength range of interest.

19. A light sensor as claimed in claim 18, wherein each pre-determined correction corresponds to a respective type of light source.

20. A light sensor as claimed in claim 18 wherein the storage means further stores, for each pre-determined correction, an expected value of the ratio of the output of the second photodetector to the output of the first photodetector and an expected value of the ratio of the output of the third photodetector to the output of the first photodetector.

21. A light sensor as claimed in claim 20 wherein the processor is adapted to compare the ratio of the output of the second photodetector to the output of the first photodetector with the stored expected values of the ratio of the output of the second photodetector to the output of the first photodetector and to compare the ratio of the output of the third photodetector to the output of the first photodetector with the stored expected values of the ratio of the output of the third photodetector to the output of the first photodetector.

22. An ambient light sensing system comprising a light sensor as defined in 18.

23. A display comprising an ambient light sensing system as defined in claim 22.

24. A display as claimed in claim 23 wherein the photodetectors are provided on a substrate of the display.

25. A display as claimed in claim 23 wherein a first colour filter of the display is disposed in an optical path to an active area of the second photodetector.

26. A display as claimed in claim 25 wherein a second colour filter of the display, having different spectral characteristics to the first colour filter, is disposed in an optical path to an active area of the third photodetector.

27. A method of measuring light intensity comprising:
measuring light intensity using a first photodetector sensitive in a first wavelength range;
measuring light intensity using a second photodetector sensitive in a second wavelength range different from the first wavelength range;
and determining, using an output of the second photodetector, a correction to an output of the first photodetector for compensating the output of the first photodetector for a difference between a spectral response characteristic of the first photodetector and a reference spectral response characteristic; wherein the first wavelength range substantially corresponds to a visible wavelength range; and wherein the second wavelength range is a part of the visible wavelength range.

28. A method as claimed in claim 27 and further comprising applying the determined correction to the output of the first photodetector thereby to compensate the output of the first photodetector for a difference between the spectral response characteristic of the first photodetector and the reference spectral response characteristic.

29. A method as claimed in claim 27 wherein the reference spectral response characteristic is the spectral response characteristic of a human eye.

30. A method comprising the steps of:
measuring light intensity using a photodetector sensitive in a first wavelength range; measuring light intensity using a second photodetector sensitive in a second wavelength range different from the first wavelength range; measuring light intensity using a third photodetector sensitive in a third wavelength range different from the first wavelength range and the second wavelength range;
storing a plurality of pre-determined corrections for compensating an output of the first photodetector for a difference between a spectral response characteristic of the first photodetector and a reference spectral response characteristic; and
selecting one of the stored corrections, using a ratio of an output of the second photodetector to an output of the first photodetector and a ratio of an output of the third photodetector to the output of the first photodetector;
wherein the first wavelength range substantially corresponds to a wavelength range of interest; wherein the second wavelength range is a part of the wavelength range of interest; and wherein the third wavelength range is another part of the wavelength range of interest.
